(19) United States
(12) Patent Application Publication
(10) Pub. No.: US 2014/0103572 A1
(43) Pub. Date: Apr. 17, 2014

(54) CASING MOLDING METHOD

(71) Applicant: Sheng-Yu Tsai, Taipei City (TW)

(72) Inventor: Sheng-Yu Tsai, Taipei City (TW)

(73) Assignee: ASUSTEK COMPUTER INC., Taipei City (TW)

(21) Appl. No.: 13/968,445

(22) Filed: Aug. 16, 2013

Related U.S. Application Data
(60) Provisional application No. 61/713,643, filed on Oct. 15, 2012.

(30) Foreign Application Priority Data
Jun. 18, 2013 (TW) 102121601

(51) Int. Cl. B29D 99/00

(52) U.S. Cl. CPC B29D 99/006
USPC 264/240

(57) ABSTRACT

A casing molding method includes following steps: providing a substrate; mixing the substrate, first hardener, second hardener, and epoxy resin in a mold to perform a first curing reaction to form a semi-manufactured product, wherein the first hardener is coated by micro capsules; and heating the semi-manufactured product to make the micro capsules ruptured and vaporized, and the first hardener contacts with the semi-manufactured product to perform a second curing reaction to form a casing.

### CROSS-REFERENCE TO RELATED APPLICATION

This application claims the priority benefit of U.S. provisional application Ser. No. 61/713,643, filed on Oct. 15, 2012, and Taiwan application serial No. 102121601, filed on Jun. 18, 2013. The entirety of the above-mentioned patent application is hereby incorporated by reference herein and made a part of specification.

### BACKGROUND OF THE INVENTION

1. Field of the Invention

The invention relates to a casing molding method and, more particularly, to a casing molding method which can perform secondary plastic deformation.

2. Description of the Related Art

To make portable electronic devices become thinner and lighter, carbon fiber material is usually used in casings of telephones, notebook computers, or other portable electronic devices. The carbon fiber material is thermosetting epoxy resin, and it needs to be stored in refrigerator in low temperature before a molding process. The carbon fiber material is usually heated to increase the molding speed in the molding process. The product cannot perform secondary plastic deformation after it is molded.

### BRIEF SUMMARY OF THE INVENTION

A casing molding method which can perform a secondary plastic deformation is provided.

The casing molding method includes following steps: providing a substrate; mixing the substrate, a first hardener, a second hardener, and epoxy resin in a mold to perform a first curing reaction to form a semi-manufactured product, wherein the first hardener is coated by micro capsules; and heating the semi-manufactured product to make the micro capsules ruptured and vaporized, and the first hardener contacts with the semi-manufactured product to perform a second curing reaction to form a casing.

These and other features, aspects and advantages of the present invention will become better understood with regard to the following description, appended claims, and accompanying drawings.

### BRIEF DESCRIPTION OF THE DRAWINGS

FIG. 1 is a flowchart of a casing molding method in an embodiment;

FIG. 2 is a schematic diagram showing a process of forming a first hardener in an embodiment;

FIG. 3 is a schematic diagram showing that a first hardener, a second hardener, and epoxy resin are uniform mixed;

FIG. 4 is a schematic diagram of a semi-manufactured product in an embodiment; and

FIG. 5 is a schematic diagram of a casing in an embodiment.

### DETAILED DESCRIPTION OF THE EMBODIMENTS

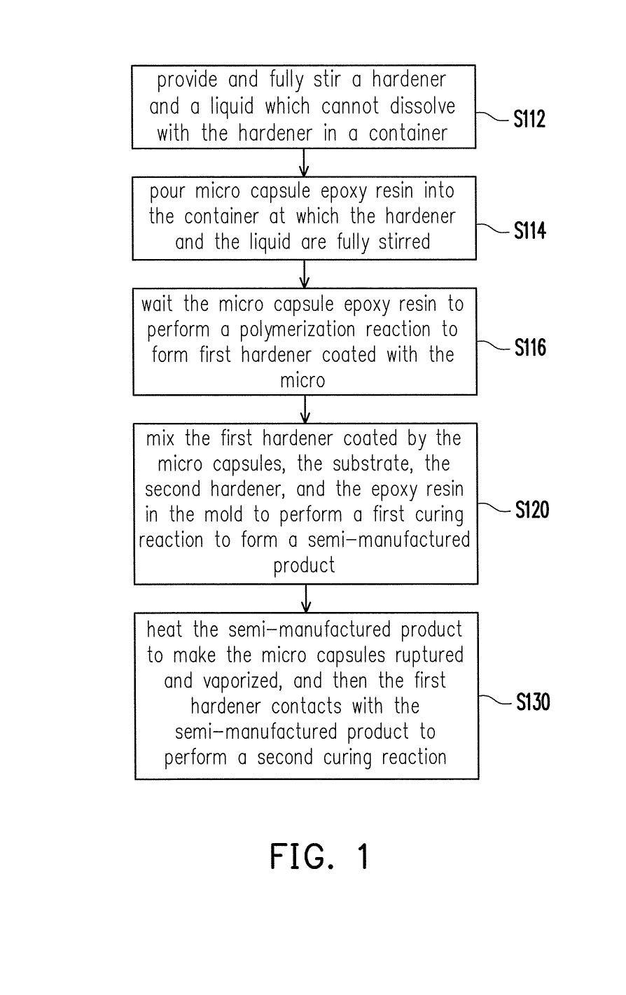

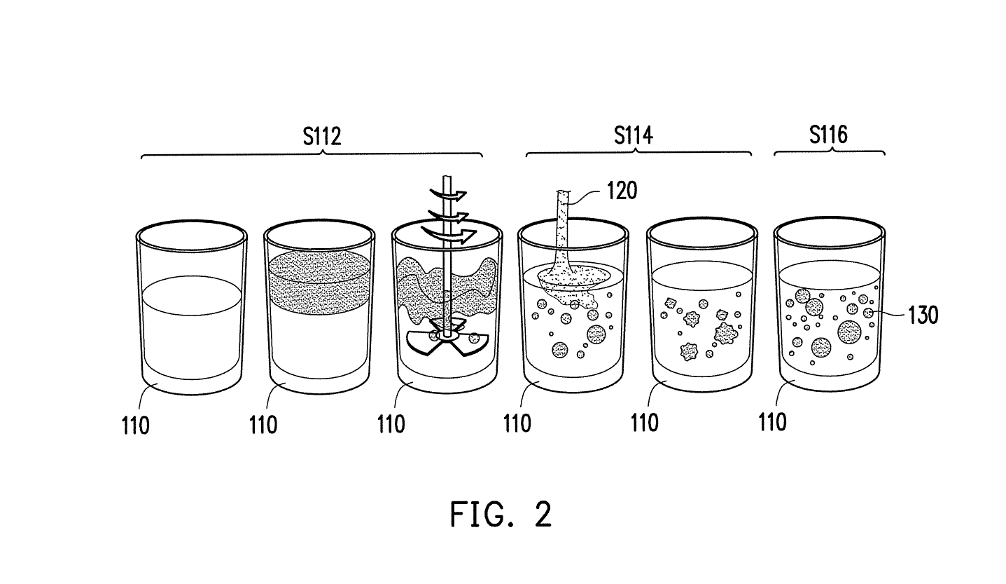

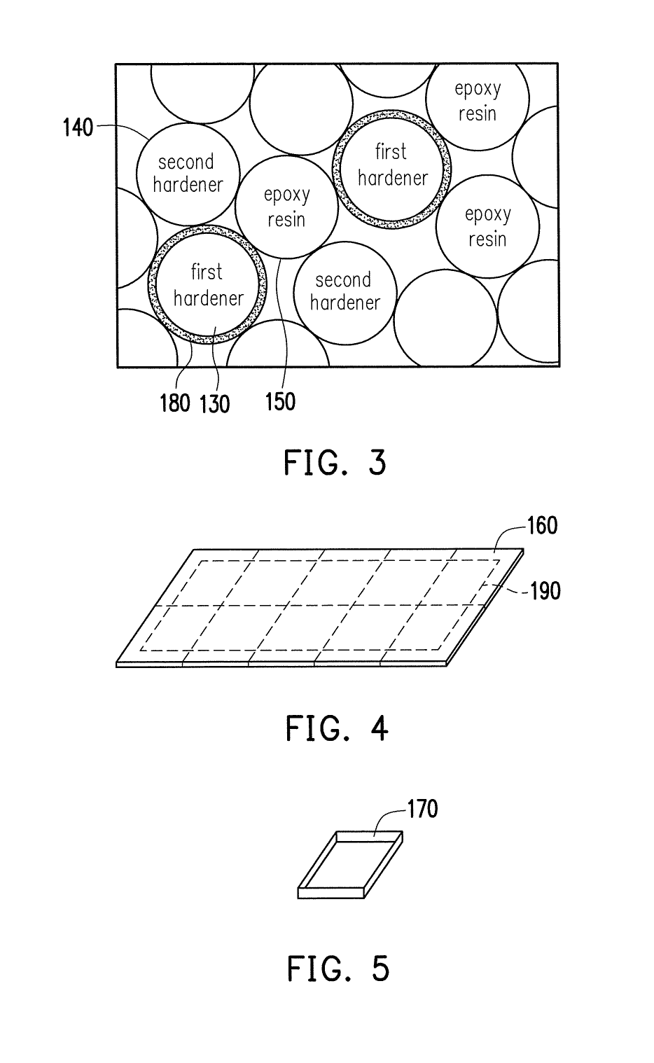

FIG. 1 is a flowchart of a casing molding method in an embodiment; FIG. 2 is a schematic diagram showing a process of forming a first hardener in an embodiment; FIG. 3 is a schematic diagram showing a first hardener, a second hardener, and epoxy resin are uniform mixed in an embodiment. Please refer to FIG. 1, FIG. 2, and FIG. 3. The casing molding method at least includes the following steps: providing a substrate; providing and fully stirring a hardener and a liquid which cannot dissolve with the hardener in a container 110 (S112); pouring micro capsule epoxy resin 120 into the container 110 at which the hardener and the liquid are fully stirred (S114); waiting the micro capsule epoxy resin 120 to perform a polymerization reaction to form the first hardener 130 coated with the micro capsules 180 (S116). Finally, filtering the liquid in the container 110 to get the micro capsules.

Then, mixing the first hardener 130 coated by the micro capsules 180, the substrate 190, the second hardener 140 uncoated by the micro capsules 180, and the epoxy resin 150 in the mold to perform a first curing reaction to form a semi-manufactured product 160 (as shown in FIG. 4), referring to step S120. In the first curing reaction, the first hardener 130, the second hardener 140, the substrate 190, and the epoxy resin 150 stand in the mold to make the second hardener 140 uncoated by the micro capsules 180 contacted with the epoxy resin 150 to form the semi-manufactured product, and the shape of the semi-manufactured product depends on the shape of the mold. The semi-manufactured product formed by the first curing reaction is a planer plate, it is convenient for printing, storing, and managing. The two dimension structure of the semi-manufactured product also can save the number of refrigerators and the storing space for the semi-manufactured product, and it is convenient to cut the semi-manufactured product into smaller size as needed. The substrate 190 is carbon fiber cloth, and the epoxy resin is selected from a group consisting of

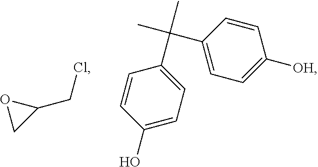 [SMILES: ClCC1CO1 ; CC(C)(c1ccc(O)cc1)c1ccc(O)cc1]

and a combination thereof; the first hardener is selected from a group consisting of

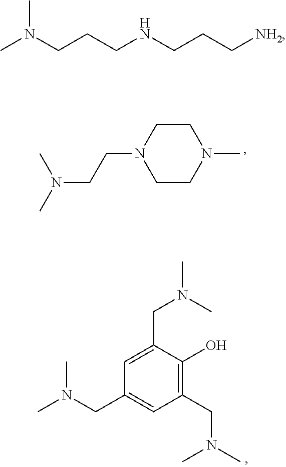

and a combination thereof; the second hardener is selected from a group consisting of

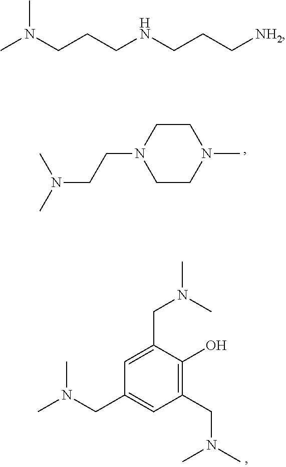

and a combination thereof. Or at least one of the first hardener 130 and the second hardener 140 is amine resin. Simply speaking, the material of the first hardener 130 and the second hardener 140 may be the same or different, which depends on the practical requirement. Furthermore, the weight percentage of the first hardener 130 coated by the micro capsules 180 in a mixture of the first hardener 130, the second hardener 140, and the epoxy resin 150 is 40% to 60%. In an embodiment, the weight percentage is about 50%.

After forming the semi-manufactured product 160 in the first curing reaction (as shown in FIG. 4), as the first hardener 130 is coated by the micro capsules 180, the first hardener 130 would not have a curing reaction with the second hardener 140 or the epoxy resin 150 when the micro capsules 180 exists. Therefore, the state of the semi-manufactured product may be kept, that is to say, the semi-manufactured product is not fully cured and also has plasticity. Meanwhile, conventionally, the first hardener 130, the second hardener 140, and the epoxy resin 150 needs to be stored in low temperature by a refrigerator to prevent the curing reaction, in comparison, the first hardener 130 and the epoxy resin 150 in the embodiment are isolated from each other due to the micro capsules 180 to prevent the curing reaction, and thus the number of devices (such as refrigerators) for storing the semi-manufactured product and the cost are saved.

Then, the semi-manufactured product is heated to about 180° C. to 200° C., the temperature is 190° C. in an embodiment, to make the micro capsules 180 ruptured and vaporized, and then the first hardener 130 contacts with the semi-manufactured product to perform a second curing reaction to form a casing 170, referring to step S130. The casing 170 formed in the second curing reaction is a three-dimensional shape (as shown in FIG. 5). The casing 170 may be formed by the planer plate in smaller size which is cut from the semi-manufactured product 160, and it also may be formed of the planer plate in an original size of the semi-manufactured product 160 which is not cut, which depends on practical requirements.

In conclusion, the casing molding method in the embodiment at least has following advantages:

Conventionally, a three-dimensional shaped casing is formed by only one curing reaction and it is not convenient to be stored, in comparison, the casing molding method in the embodiment utilizes the micro capsules to isolate the first hardener from contacting with the epoxy resin, and makes the second hardener uncoated by the micro capsules first contact with the epoxy resin to perform the first curing reaction, so as to form the semi-manufactured product which is plastic and two-dimensional, and thus it is convenient to be printed, stored, managed, and transferred.

Conventionally, the refrigerator is used to keep the first hardener, the second hardener, and the epoxy resin in low temperature to prevent the curing reaction, in comparison, when the first curing reaction is performed in the casing molding method in the embodiment, the first hardener coated by the micro capsules and the epoxy resin are isolated with each other to avoid the curing reaction therebetween, so the number of devices (such as refrigerators) for storing the semi-manufactured product and the cost are saved.

The micro capsules can prevent the second curing reaction being performed spontaneously at normal temperature, and thus the material of the first hardener and the second hardener has a wide range of choice.

The temperature of heating the micro capsules to be ruptured and vaporized is low, so the temperature needed in the casing molding method in the embodiment is lower than the heating temperature in prior art. In other words, a shorter time is needed to perform the curing reaction to form the casing.

The twice plastic molding is performed in the casing molding method in the disclosure, and the shape of the secondary plastic molding can be shaped after the first plastic molding, consequently, the steps of reprocessing and the steps of the process are decreased.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A casing molding method, comprising:
providing a substrate;
mixing the substrate, a first hardener, a second hardener, and epoxy resin in a mold to perform a first curing reaction to form a semi-manufactured product, wherein the first hardener is coated by micro capsules; and
heating the semi-manufactured product to make the micro capsules ruptured and vaporized so as to make the first hardener contact with the semi-manufactured product to perform a second curing reaction to form a casing.

2. The casing molding method according to claim 1, wherein the first hardener is selected from a group consisting of 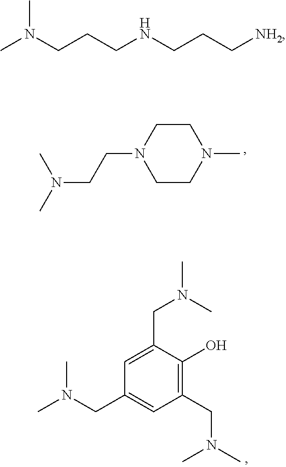
and a combination thereof.

3. The casing molding method according to claim 1, wherein the second hardener is selected from a group consisting of 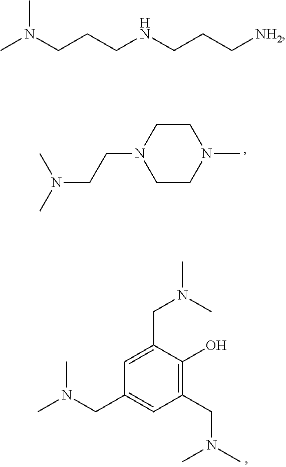
and a combination thereof.

4. The casing molding method according to claim 1, wherein the epoxy resin is selected from a group consisting of 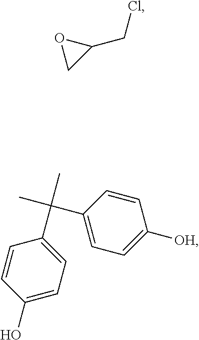 [SMILES: ClCC1CO1 ; CC(C)(c1ccc(O)cc1)c1ccc(O)cc1]
and a combination thereof.

5. The casing molding method according to claim 1, wherein the step of forming the first hardener comprises:
providing and fully stirring a hardener and a liquid which is immiscible with the hardener in a container;
providing micro capsule epoxy resin into the container at which the stirred hardener and the liquid are fully stirred; and
waiting the micro capsule epoxy resin to perform a polymerization reaction to form the first hardener coated with the micro capsules.

6. The casing molding method according to claim 1, wherein the weight percentage of the first hardener in a mixture of the first hardener, the second hardener, and the epoxy resin is 40% to 60%.

7. The casing molding method according to claim 1, wherein the temperature of heating the semi-manufactured product is 180° C. to 200° C.

8. The casing molding method according to claim 1, wherein the semi-manufactured product formed in the first curing reaction is planer-plate shaped, and the casing formed in the second curing reaction is three-dimensional shaped.

9. The casing molding method according to claim 1, wherein the substrate is carbon fiber cloth.

10. The casing molding method according to claim 1, wherein at least one of the first hardener and the second hardener is amine resin.
